(19) United States
(12) Patent Application Publication
(10) Pub. No.: US 2002/0065651 A1
(43) Pub. Date: May 30, 2002

(54) Dialog system

(76) Inventors: Andreas Kellner, Aachen (DE); Bernd Souvignier, Nijnegen (NL); Thomas Portele, Bonn (DE); Petra Philips, Aachen (DE)

Correspondence Address: U.S. Philips Corporation, 580 White Plains Road, Tarrytown, NY, 10591, US

(21) Appl. No.: 09/954,657

(22) Filed: Sep. 18, 2001

(30) Foreign Application Priority Data
Sep. 20, 2000 (DE) 10046359.2

(51) Int. Cl. G10L 15/00

(52) U.S. Cl. 704/231

(57) ABSTRACT

The invention relates to a dialog system (1) which has a most comfortable and effective dialog structure for a user, comprising processing units for

automatic speech recognition (3),

natural language understanding (4),

defining system outputs in dependence on information (7) derived from user inputs,

generating acoustic and/or visual system outputs (9, 10, 11, 12),

deriving user models, while the user models contain details about the style of speech of user inputs and/or details about interactions in dialogs between users and the dialog system (1) and adaptation of contents and/or form of system outputs is provided in dependence on the user models.

The invention relates to a dialog system comprising processing units for automatic speech recognition, for natural language understanding, for defining system outputs in dependence on information derived from user inputs and for generating acoustic and/or visual system outputs.

Such a dialog system is known, for example, from the article “The Thoughtful Elephant: Strategies for Spoken Dialog Systems” by Bernd Souvignier, Andreas Kellner, Bernd Rüber, Hauke Schramm and Frank Seide, IEEE Transactions on Speech and Audio Processing, 1/2000. The described system is used, for example, as an automatic train information system or automatic telephone directory assistance system. The described dialog system has an interface to the telephone network via which the spoken inputs of a user are received and applied as electric signals to a speech recognition unit. The recognition results produced by the speech recognition unit are analyzed as regards their sentence contents by a natural language understanding unit. In dependence on the detected sentence contents and application-specific data stored in a database, a dialog control unit generates, with the aid of the text/speech converter, a spoken output which is transmitted via the interface and the telephone network. In chapter VII “Usability Studies” is observed that inexperienced users rather prefer self-explanatory system outputs with additional information, whereas experienced users prefer as short a dialog as possible with simple system outputs. The introduction of user models is proposed that affect the dialog management.

It is an object of the invention to provide a dialog system having as comfortable and effective a dialog management for a user as possible.

The object is achieved by the dialog system as claimed in claim 1 and the method as claimed in claim 7.

In the dialog system according to the invention, the contents and form of the system outputs are adapted to the style of speech of user inputs and/or to the behavior of a user during a dialog with the dialog system. The details about the style of speech and dialog interactions of a user are contained in an associated user model which is evaluated by the dialog system components. The dialog system is thus in a position to generate system outputs adapted to a user's style of speech with a style of speech considered pleasant by the respective user. As a result, the inhibition threshold of the use of the dialog system can be lowered. Both the contents of the sentences and also the syntax of system outputs are adapted by the dialog system according to the invention, so that a dialog structure is made possible in which a dialog to be held with a user is experienced by him as pleasant and, furthermore, the dialog with the user is held highly effectively. Also a user's interaction behavior is incorporated in the associated user model so that, more particularly, the output modalities used by the dialog system during a dialog are used as well as possible in dependence on the use of various available input modalities (see claim 2). In some cases a pure speech output may be the result, in other cases an output of signal tones and again in other cases a visual system output. More particularly, various output modalities may also be used in combined version to guarantee an effective communication with the user. A concentration to those output modalities takes place with which the user achieves the highest rates of success. The dialog system may provide optimal help for a user to achieve his dialog object while taking his requirements and abilities into account.

The embodiment according to claims 3 and 4 makes it possible to adapt the dialog structure when user inputs are recognized with different reliability. So-called confidence measures can be used in this respect. If a recognition result is recognized as unreliable, the user may be requested, for example, to confirm the recognition result, or by suitable system outputs, be prompted to use other input modalities.

The claims 5 and 6 indicate possibilities to determine user models. The use of fixed models for user stereotypes is advantageous in that an extensive user model can be assigned to a user already with few dialog data.

These and other aspects of the invention are apparent from and will be elucidated with reference to the embodiment(s) described hereinafter.

In the drawings:

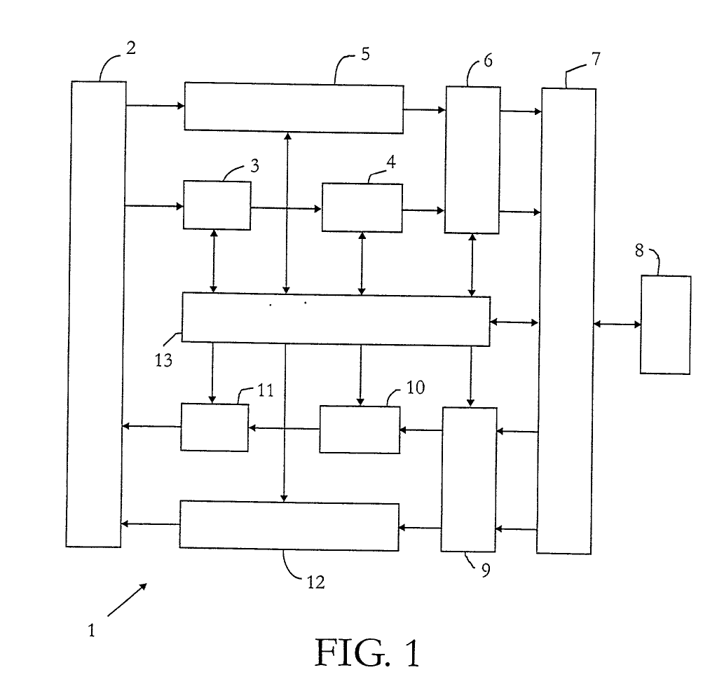

FIG. 1 shows a block diagram of a dialog system and

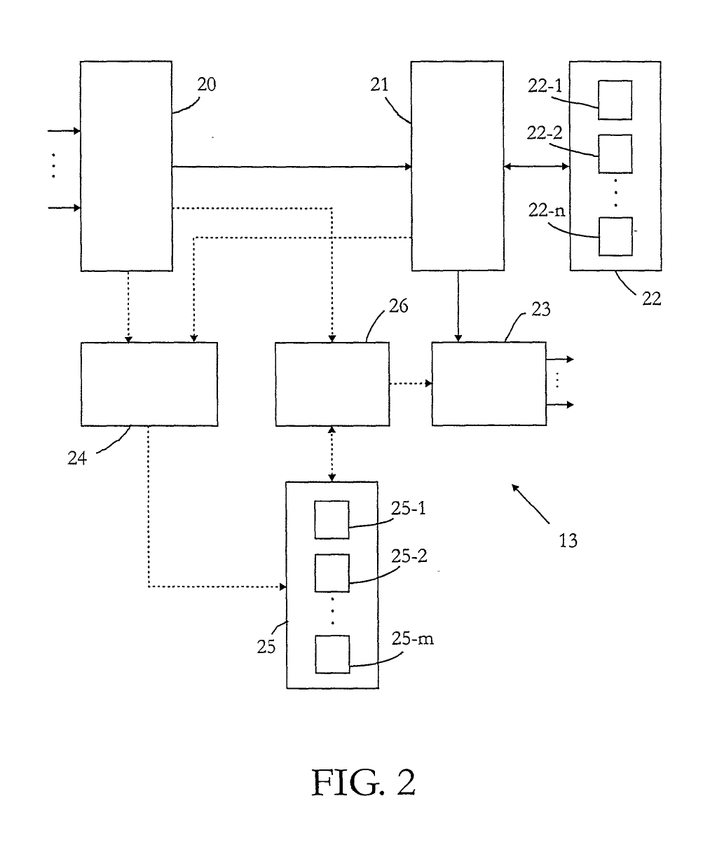

FIG. 2 shows a block diagram for processing the user model in the dialog system shown in FIG. 1.

The dialog system 1 shown in FIG. 1 includes an interface 2 via which the user inputs are applied to the dialog system 1. The user inputs are preferably speech signals, but also other input modalities such as the input per computer mouse, touch screen, sign language or handwriting recognition is possible. Speech inputs are subjected to customary speech recognition algorithms (block 3) and algorithms for natural language understanding (block 4). User inputs, while using other input modalities, such as the input per computer mouse, are recognized and interpreted by a processing unit featured by block 5. A block 6 integrates the signals produced by the two branches (block 3 and 4, on the one hand, and block 5, on the other) and therefrom generates a signal that represents the relevant information in the user inputs, which signal is processed by a dialog controller 7, which determines the dialog structure. This dialog controller accesses a database 8, which contains application-specific data, and defines system outputs in order to hold a dialog with the user. Block 9 features the destination of the best possible output modality or output modalities, respectively, for the system outputs for the respective user. The processing according to block 9 could also be defined as an integral part of the processing by the dialog controller 7. Block 10 features the formation of whole sentences, which are generated on the basis of the information produced by the block 9. Block 11 represents a text/speech converter, which converts the sentences produced by the unit 10 and available as text, into spoken signals which are transmitted to the user via the interface 2. The generation of system outputs by means of other output modalities, more particularly, the generation of visual system outputs, is featured by the block 12 lying in parallel with the blocks 10 and 11.

A block 13 features a user model processing with user models which are generated in dependence on information that is derived from the processing procedures of blocks 3, 4, 5, 6 and 7. In dependence on the user models determined thus, the processing procedures are adapted in accordance with the blocks 7, 9, 10, 11 and 12.

When user models are generated, more particularly the style of speech and interactions occurring between user and dialog system are taken into account.

When the style of speech of a user input is determined, for example evaluations with respect to the following characterizing features are made:

number of polite phrases used,

address used (you),

speech level (colloquial language, standard language, dialect)

information density (number of words recognized as significant of a speech input in relation to the total number of words used),

vocabulary and use of foreign words,

number of different words in user inputs,

classification of words of speech inputs with respect to rare occurrence.

In dependence on the determined style data, the style of speech outputs is adapted, i.e. respective polite phrases and the same address are used, the speech level is adapted to the detected speech level; in dependence on the information density in a speech input more or fewer extensive system outputs are generated and the vocabulary used for the speech outputs is selected accordingly.

When interaction samples are determined, there is particularly detected what input modalities a user has used and how the individual input modalities respectively combine. More particularly, an evaluation is made in how far a user changes between various input modalities or also simultaneously uses various input modalities for inputting a certain piece of information. An interaction sample is also a possibility that a user simultaneously uses various pieces of information while using a respective number of input modalities (thus, for example, simultaneously utilizes two entries with different information contents). An interaction sample in a user model is represented by respective a priori probability values which are taken into account during the processing according to block 6 (multimodal integration).

In accordance with the user's style and the interaction sample occurring during a dialog with such a user, a user model is generated with the aid of which an adaptation of contents and/or form of system outputs of the dialog system is provided. System outputs are generated based on this adaptation, so that a dialog to be held with the user is experienced as pleasant by the user and, furthermore, the dialog with the user is held as effectively as possible. For example, it is ascertained in how far possibilities for metacommunication (for example, help functions/assistants) are rendered available to the user by the dialog system. In one user model will particularly be entered information about knowledge of paradigms (experience with the use of dialog systems) and knowledge of assignments (know what type of user inputs are at all necessary to obtain information from the dialog system). Furthermore, to improve the error rate for the recognition of user inputs, also the processing processes of blocks 3, 4, 5 and 6 are adapted. More particularly, probability values are adapted, which are used for the speech recognition and natural language understanding algorithms (for example, adaptation to the style of speech found).

Also the respectively reached progress of discourse achieved in a dialog between user and dialog system can have an effect on the adaptation of a user model. This progress may be detected in that it is determined in how far so-called slots (variables representing information units, see article “The Thoughtful Elephant: Strategies for Spoken Dialog Systems”) are filled with concrete values by the input of suitable information by the user. The progress of discourse also depends on how far the contents of slots were to be corrected, for example, due to erroneous recognition, or because the user did not meet a clear goal. By monitoring the progress of a user's discourse, there may be determined in how far this user is familiar with the dialog system. A user model can, moreover, also contain information about the call for help functions or also a user's “degree of despair”, which expresses itself in respective facial play (to detect this, a camera and respective image processing should be provided) and helplessness/confusion while the dialog is being held.

In an embodiment of the dialog system according to the invention there is furthermore provided to determine estimates for the reliability of user inputs and include the estimates in the user models. Also so-called confidence measures can be used for this, which have been described for the speech recognition range, for example, in DE 198 42 405 A1. In a user model the estimates for the reliability of recognition results derived from user inputs are stored and assigned to the respective user. Dialog system responses to user inputs are generated in dependence on the reliability estimates. The respective user is then prompted to use such input modalities for which high reliability estimates were determined and/or refrain from using input modalities having low reliability estimates. If, for example, three input modalities are available, the user is requested for a first alternative either to use the input modality that has the highest reliability estimate, or to use the two input modalities that have the two highest reliability estimates. For the other alternative the user is requested not to use the input modality that have the lowest reliability estimate, or the two input modalities that have the two lowest reliability estimates. The user can directly (“Please use ”/“Please do not use”) or also indirectly (without explicit request by suitable dialog formation) be prompted to use or not use, respectively, the input modalities.

If a recognition result is recognized as unreliable, the user can be requested, for example, also to confirm the recognition result. In addition, the degree with which the user is informed of the current system knowledge, is adapted in accordance with the degree of reliability of the user inputs so as to give the user the possibility of correction in case of erroneously recognized inputs. Furthermore, the reliability estimates of the various input modalities can be used for the purpose of adapting the processing in accordance with block 6, or adapting the a priori probabilities, respectively.

FIG. 2 explains the user model processing 13 of the dialog system 1. A block 20 features an analysis of user inputs, more particularly, with respect to the style of speech used and/or the interaction sample used, thus the extraction of certain features that can be assigned to the user. A block 21 features the assignment of a fixed model of a user stereotype determined a priori from a plurality of fixed user stereotypes 22-1, 22-2 to 22-n defined a priori, which are combined by a block 22. Basically, also an assignment of various fixed models of user stereotypes to current users can take place, which are subsequently combined. Block 23 features the conversion of the user model determined in block 21 into an adaptation of the dialog system 1, where contents and/or form of system outputs are adapted in dependence on the determined user model; furthermore, also the processing means of the blocks 3 to 6 are adapted.

Block 24 features a calculation of an updated user model for a user. The update of a user model is a continuous one based on the analysis data determined by block 20. More particularly, a fixed user model determined in block 21 on the basis of one or various user stereotypes is used as a basis and adapted. Block 25 features updated user models 25-1, 25-2 to 25-n which are combined by a block 25. A block 26 represents the selection of one of the updated user models from block 25 independence on the analysis data of the block 20, while an adaptation of the dialog system 1 made in block 23 with the aid of the selected updated user model.

1. A dialog system (1) comprising processing units for
automatic speech recognition (3),
natural language understanding (4),
defining system outputs in dependence on information (7) derived from user inputs,
generating acoustic and/or visual system outputs (9, 10, 11, 12),
deriving user models (22, 25), while the user models (22, 25) contain details about the style of speech of user inputs and/or details about interactions in dialogs between users and the dialog system (1) and adaptation of contents and/or form of system outputs is provided in dependence on the user models (22, 25).

2. A dialog system as claimed in claim 1, characterized
in that in addition to the input modality to use user inputs by means of speech, at least a further input modality is provided and
in that the user models (22, 25) contain details about the respective use of the various input modalities by the user.

3. A dialog system as claimed in claim 1 or 2, characterized
in that the user models (22, 25) contain estimates for the reliability of recognition results derived from user inputs.

4. A dialog system as claimed in claim 3, characterized
in that in dependence on the estimates, system responses are generated which prompt the respective user to use such input modalities for which high estimate values were determined and/or which prevent the respective user from using input modalities for which low reliability values were determined.

5. A dialog system as claimed in one of the claims 1 to 4, characterized
in that fixed models of user stereotypes (22) are used for forming the user models.

6. A dialog system as claimed in one of the claims 1 to 5, characterized
in that user models (25) are used which are continuously updated based on inputs of the respective user.

7. A method of operating a dialog system, in which processing units are used for
automatic speech recognition (3),
natural language understanding (4),
defining system outputs in dependence on information (7) derived from user inputs,
generating acoustic and/or visual system outputs (9, 10, 11, 12), and
deriving user models (13),
while the user models contain details about the style of speech of user inputs and/or indications about interactions in dialogs between users and the dialog system (1) and an adaptation of contents and/or form of system outputs is provided in dependence on the user models (22, 25).
